(19) United States
(12) Patent Application Publication
(10) Pub. No.: US 2016/0180367 A1
(43) Pub. Date: Jun. 23, 2016

(54) MOBILE SAMPLING & PROMOTION SYSTEM AND METHOD

(71) Applicant: Barkudo LLC, Cleveland, OH (US)

(72) Inventors: Trevor Chapin Shaw, Cleveland Heights, OH (US); Bradley Thomas Philips, Akron, OH (US)

(21) Appl. No.: 14/976,527

(22) Filed: Dec. 21, 2015

Related U.S. Application Data
(60) Provisional application No. 62/094,234, filed on Dec. 19, 2014.

(51) Int. Cl. G06Q 30/02

(52) U.S. Cl. CPC G06Q 30/0222; G06Q 30/0255; G06Q 30/0261; G06Q 30/0267

(57) ABSTRACT

A method and system for the conducting sampling campaigns and instantly-redeemable-coupon promotions in bars and restaurants on behalf of major alcohol manufacturers and distributors using mobile phones.

### CROSS-REFERENCES TO RELATED APPLICATIONS

This application claims the benefit of U.S. provisional patent application Ser. No. 62/094,234 which was filed on Dec. 19, 2014, and is incorporated herein by reference.

### FIELD OF THE INVENTION

This application relates to the field of mobile applications and digital marketing. More particularly, the application relates to a way of conducting sampling campaigns and instantly-redeemable-coupon promotions in bars and restaurants on the behalf of major alcohol manufacturers and distributors using mobile phones.

### BACKGROUND

For decades alcohol manufacturers have experimented with ways of driving consumer demand for their products. One of the oldest and most common forms of marketing is to conduct “Sampling Promotions” whereby a manufacturer will send a representative to a bar or restaurant to purchase sample servings of the product so that they can give customers a taste of their brand.

For many years, sending promotional representatives into nightlife venues has been the preferred method of conducting these promotions. Manufacturers and/or distributors will send in company representatives or will hire third party companies (e.g., Team Enterprises, Greenhouse Agency, etc.) to send models to a bar to purchase and hand out sample servings. Promotional models are hired and used to represent the brand and to convey the brand message to consumers. Moreover, such models are often asked to provide “recaps” of the promotion to relay information back to the manufacturer about which demographics of consumers were most connected with the brand. This process is highly subjective and relies entirely on the best estimation of the representatives attending the promo event, and can be very costly.

Alcohol laws vary from state to state, but many states have strict legal limits on how many samples may be distributed to a single consumer on a given night. Third party marketing teams are often instructed to respect these limits, but often have great difficulty in preventing over serving to patrons.

### BRIEF SUMMARY

Provided are a plurality of example embodiments, including, but not limited to, a method of providing a promotion for an alcoholic beverage, said method comprising the steps of:
providing a software application for installation on a portable user device over a communication network from a remote app server;
installing the software application on the portable user device;
executing the software application on the user device to detect a user location near or at a vendor;
executing the software application on the user device to provide a user interface on the portable user device to collect information about the user;
executing the software application on the user device to receive information about an offer to sample or purchase a product at the vendor from a remote computer system located remotely from the vendor;
executing the software application on the user device to provide a user interface on the portable user device to display the offer at the vendor;
executing the software application on the user device to provide a user interface on the remote device to receive a user input regarding acceptance of the offer;
if the offer is accepted via the user interface, executing the steps of:
the software application on the user device providing information about the offer to the remote computer system,
the remote computer system providing information about the accepted offer to a vendor device located at the vendor location,
after delivery of the product, the vendor device sending product promotion information over the communication network regarding the delivered product to the remote computer system,
the remote computer system executing software for preparing a promotion report based on the product promotion information and the information about the user, and;
transmitting the promotion report to a supplier computer system over the communication network.

Also provide are any of these methods wherein if the offer is accepted via the user interface, a number of other offers provided to the portable device on the same day are limited to a predetermined number.

Also provide are any of these methods wherein a payment must be provided to the vendor by a patron using the portable device prior to delivering the product.

Also provide are any of these methods wherein if the offer is accepted via the user interface, a payment is subsequently provided by the supplier to the vendor.

Also provide are any of these methods wherein if the offer is accepted via the user interface, a payment is subsequently provided by the supplier to the vendor.

Also provide are any of these methods wherein said user device also sends information about the accepted offer to the vendor device.

Also provided is a system for executing any of the above methods, said system comprising a portable computing device for use by a consumer, a vendor device, one or more servers comprised in the remote computer system, and a supplier computer system.

Also provided are additional example embodiments, some, but not all of which, are described herein below in more detail.

### BRIEF DESCRIPTION OF THE DRAWINGS:

The features and advantages of the example embodiments described herein will become apparent to those skilled in the art to which this disclosure relates upon reading the following description, with reference to the accompanying drawings, in which:

FIG. 1 displays a general overview of the functional workflow of the Barkudo sampling process. This is a top level overview of how Barkudo interacts with different tiers of the industry.

FIG. 2 Displays the consumer facing mobile application that is used to discover, view, and redeem deals within the Barkudo platforms.

FIG. 3 displays a redemption screen of the mobile application that is used at the point of sale to receive the deal.

FIG. 4 displays the client-side portal where deals can be viewed

FIG. 5 displays the client-side portal where deals are being created

FIG. 6 displays the client-side portal where analytics are viewed

FIG. 7 depicts a diagram of the high level interaction of client devices as it relates to the disclosed embodiment.

FIG. 8 depicts the system components as related to the disclosed embodiments.

FIG. 9 illustrates a flowchart representing a merchant creating a promotion as it relates to the disclosed embodiments.

FIG. 10 illustrates a flowchart of a deal lookup as it relates to the disclosed embodiments.

FIG. 11 illustrates a flowchart of redemption of the sampling promotion as it relates to the disclosed embodiment.

FIGS. 12a-12c illustrate, in combination, a Barkudo domain model as it relates to the disclosed embodiment; and

FIGS. 13a-13d illustrate, in combination, an example marketing report as it relates to the disclosed embodiment.

### DETAILED DESCRIPTION OF EXAMPLE EMBODIMENTS

Barkudo (an example embodiment of the disclosed system and method) is a software solution that allows sampling promotions to be run digitally through a mobile application.

Barkudo is also a software company that provides the service of publishing and selling a smartphone app (also called “Barkudo”) that provides real-time location based nightlife information to consumers. The app is a download that is available on a variety of mobile hardware devices and operating system platforms. The app may be provided for free, or for a charge. No charge is preferable since it is desirable to encourage use of the app. Consumers are able to download the Barkudo mobile application from the Apple Store and Google Play to find nightlife deals, specials, events, and venues in their area. Upon opening the application, Barkudo uses location data to identify the user's location and displays deals in 10 mile radius around that user.

Alcohol manufacturers (e.g. Proximo Spirits, Campari, North American Breweries, etc.) hire Barkudo to create and run on premise sampling promotions and Instantly-redeemable-coupon campaigns at nightlife locations.

Rather than send in-house or third party representatives (e.g., distributors and models) to purchase and distribute sample servings to patrons of a bar or restaurant, Barkudo creates a deal on our mobile application that allows Barkudo users to go to the venue and redeem the Sample Serving directly from the bartender.

Barkudo promotions are rarely scheduled in “one-off” instances and are more often rolled into a larger campaign that is comprised of a series of individual promotions.

To begin a campaign, a manufacturer selects a brand to advertise, a region to target, and a budget to allocate towards the marketing effort. Barkudo, along with the supplier, identify target accounts in which to schedule promotions to satisfy the marketing objectives of the supplier while staying within the constraints set by the budget. Retail accounts, upon agreeing to participate in the sampling program, purchase the necessary product that is to be sampled so that the promotion can be conducted. Barkudo pays the retail account to purchase discrete “Sample Servings” of the product so that a deal can be created to sample the product to consumers.

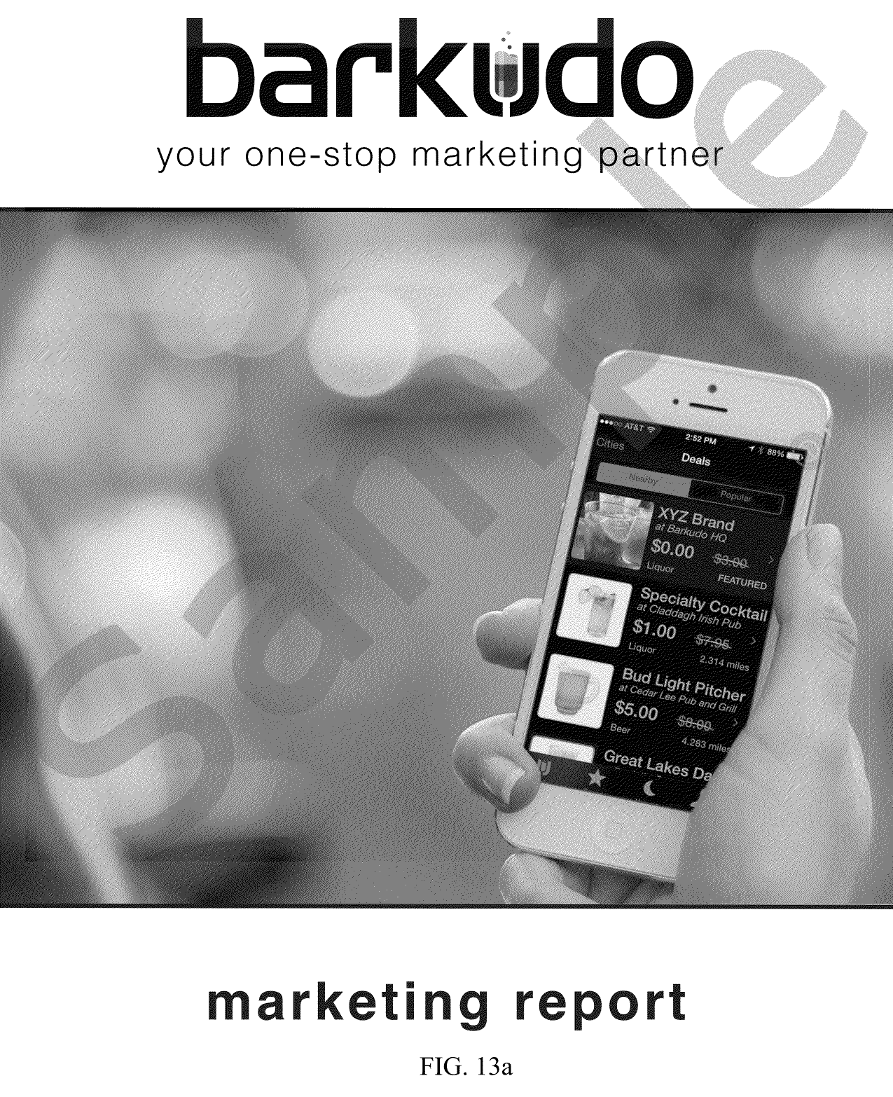

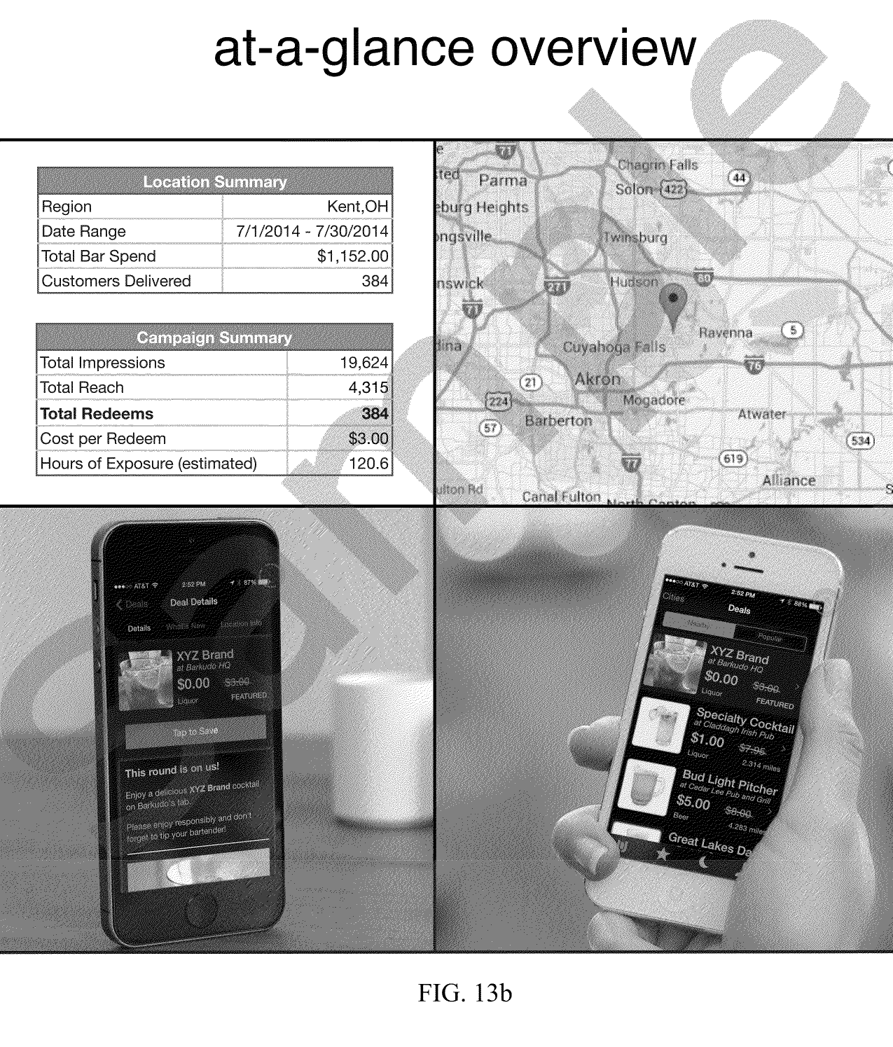

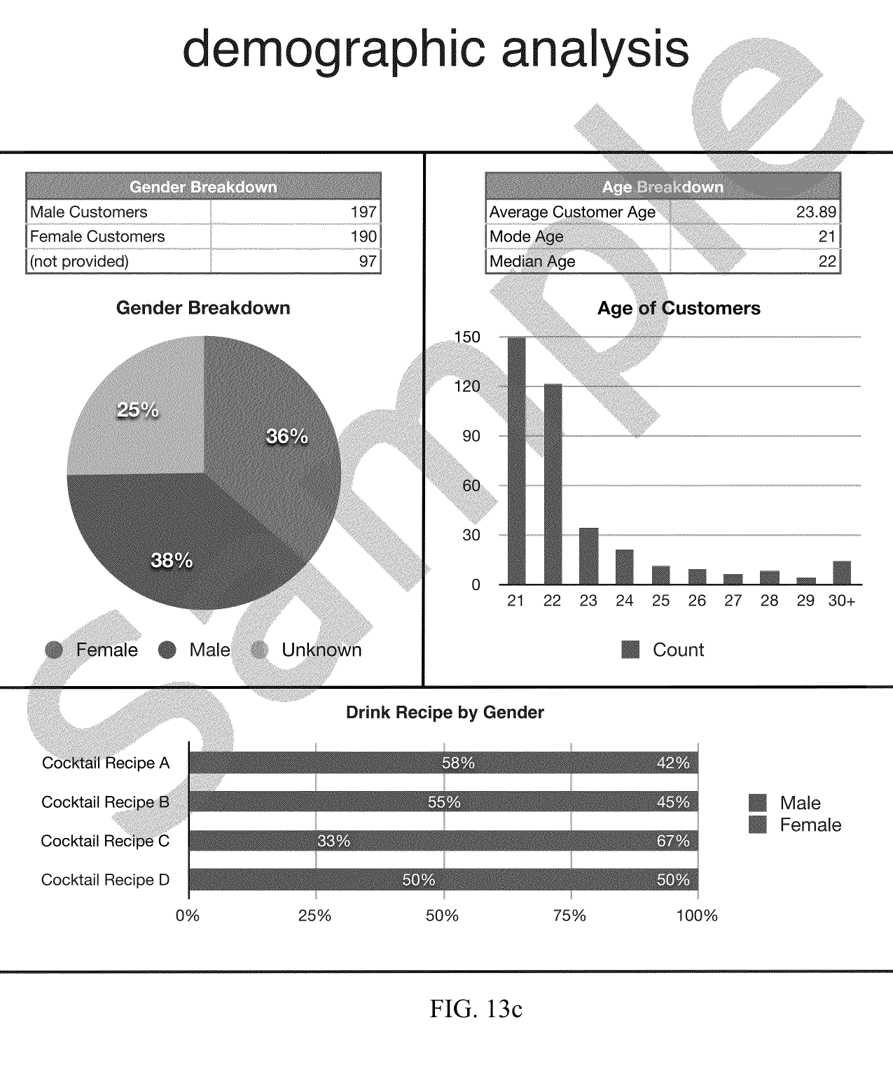

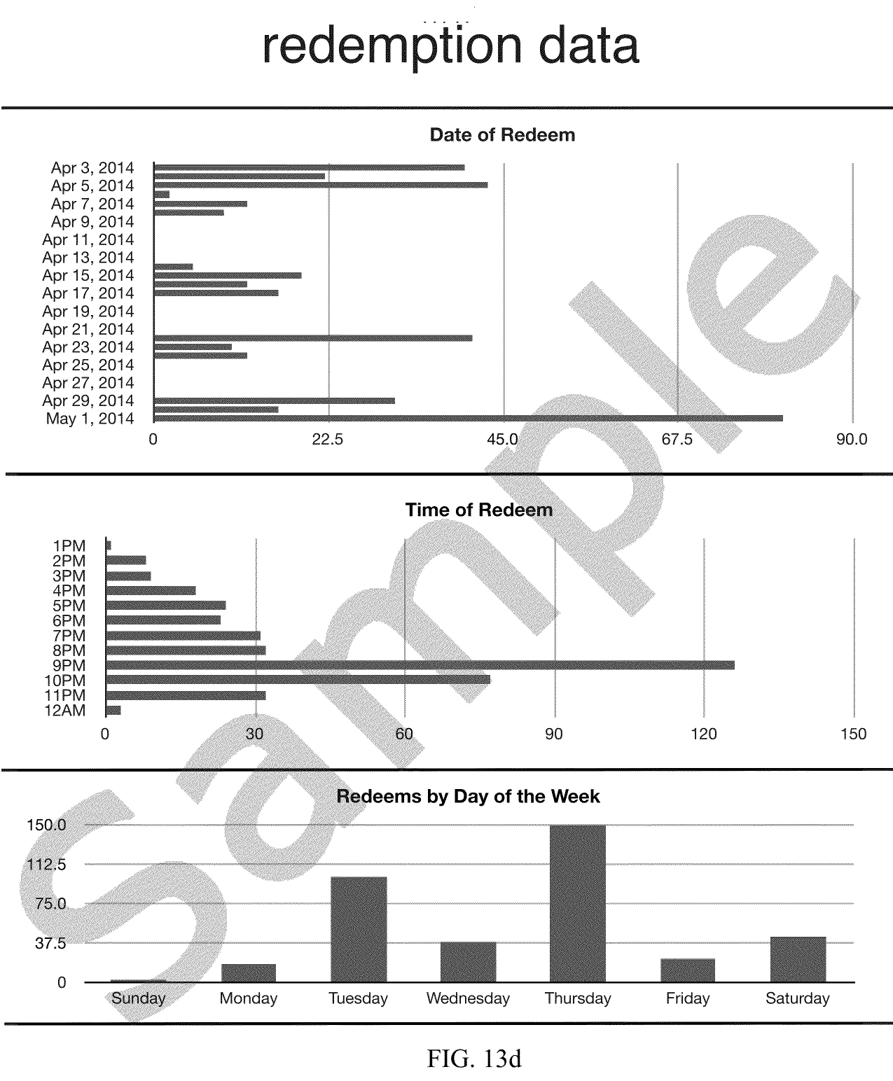

The Barkudo application allows (and may require) consumers to create an account and provide personal information prior to having the ability to redeem deals, so Barkudo is able to deliver reports to the manufacturer that gives detailed demographic information about consumer engagement that is built upon objective data. The data collected and returned to the manufacturer includes—but is not limited to—information regarding age, sex, zip code, redemption time, and consumer feedback regarding the product sampled. These reports are generated after the conclusion of a campaign and can be distributed physically or digitally at the preference of the supplier. An example of such a report is shown in FIGS. 13a-13d.

Lastly, Barkudo associates each such “redeem” with a unique phone ID. This allows Barkudo to securely limit the number of samples distributed to the consumer and helps us prevent the over serving commonly seen in the industry today. In this manner, state legal limits on the number of samples provided (i.e., to a predetermined number) can be accommodated on a state-by-state basis (the system can use the location of the client to determine applicable state limits that can be applied to the current situation).

Provided are additional example embodiments, some, but not all of which, are described herein below in more detail.

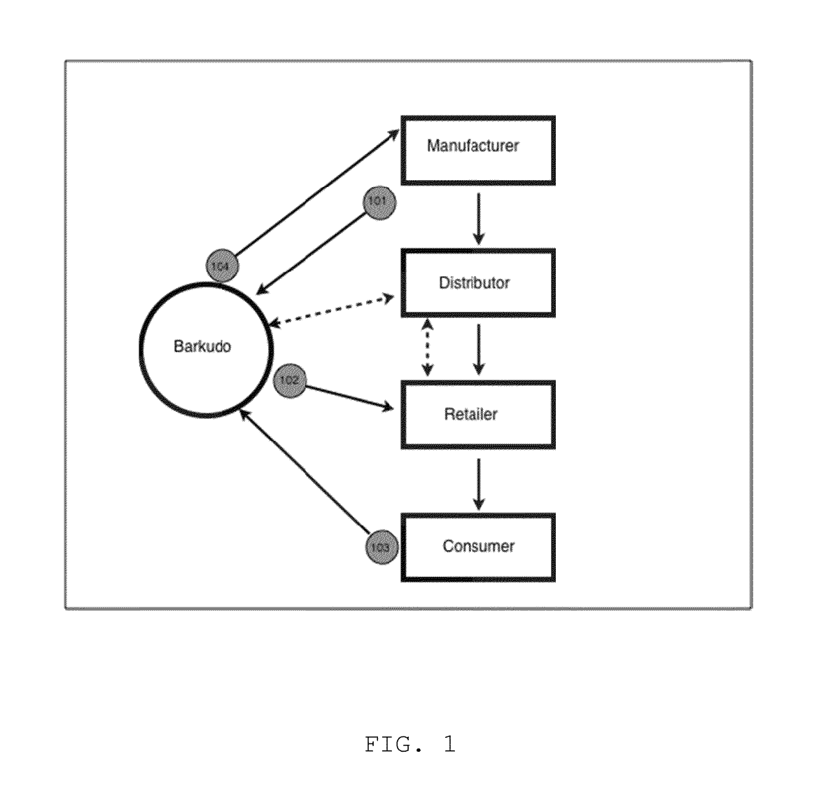

FIG. 1 provides a generic top level graphic that outlines the basic functional workflow of a Barkudo sampling promotion or IRC campaign. The process typically begins when a manufacturer authorizes Barkudo to set up and execute a series of promotions (101).

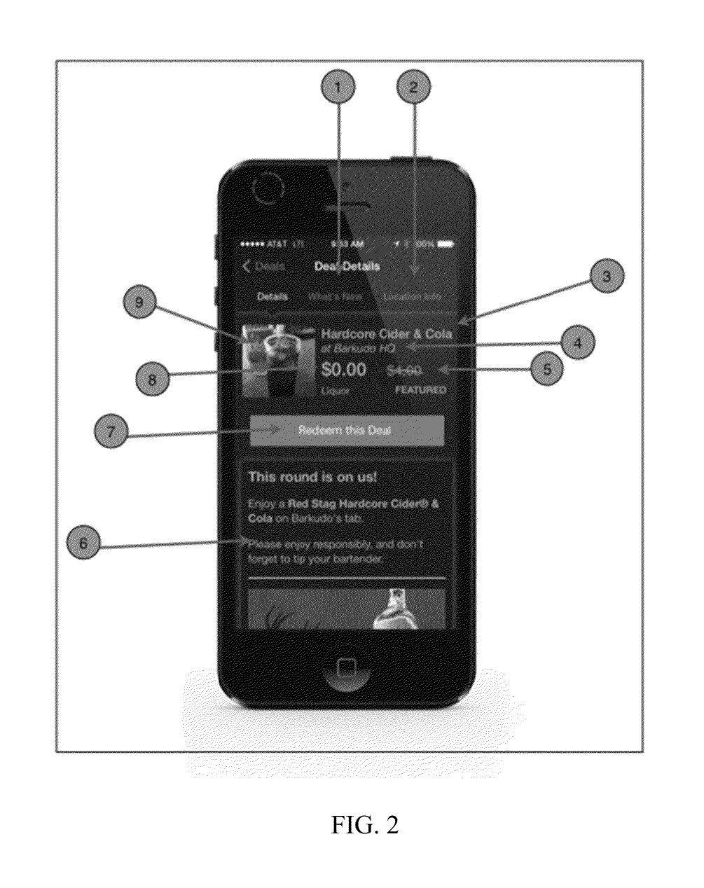

As an example, let's imagine “Manufacturer XYZ” hires Barkudo to promote a new brand of Vodka that it is releasing in Cleveland, Ohio and is willing to spend $10,000 towards the marketing of the product. Once a budget has been established, Barkudo proceeds to approach bars and restaurants within Cleveland, Ohio and purchases a predetermined number of “Sample Servings” of Manufacturer XYZ's product from venues at retail cost (102). Once Barkudo has purchased the predetermined number of Sample Servings from the venue, Barkudo creates a Barkudo deal (FIG. 2) that will be redeemable by consumers at the venue in question.

Consumers will use an example of the disclosed process (e.g., software app) to discover venues that are running the sampling promotions and can use the software app, itself, as a redemption mechanism to receive the sample that is being distributed (103). Each redemption that occurs at a specific venue is measured and is deducted from the total number of redemptions remaining at that venue.

In order to redeem Barkudo deals, consumers must sign up by providing information including name, age, gender, zip code, and email address, among other personal information, for example. Once the predetermined limit has been reached and all authorized redemptions have been redeemed (or a time period has elapsed), Barkudo assembles data reports that are forwarded to the manufacturer to provide demographic insights regarding the consumers who redeemed samples of their brand (104). See, for example, FIGS. 13a-13d for an example report.

FIG. 2 shows the consumer facing portion of the example software application as it appears on an iPhone 5 mobile device (“the App”). This mobile application can be provided on iOS and Android operating systems, for example, however the back-end of the service could be made to integrate into other software platforms, as desired.

Users are free to explore the app to discover and learn about product samples or suggested purchases that are being offered in their geographical area, or in other geographical areas.

FIG. 2. displays how the App organizes the data being viewed by the consumer. The App user can scroll to links (1) or (2) to discover Social Media or general location info about the venue that is hosting the deal. The venue that is offering the deal is designated (4).

The deal is named by (3) and the “normal” price and “discounted” price are named by (4) and (8) respectively.

A simple “Featured” designation (5) highlights that a deal is a Sample Serving relative to other “generic” deals that are offered on the platform which can be accepted by the client (customer/user) to sample or purchase (such as at a discount) the offered product.

Marketing copy and specific branding assets can be pulled across and viewed within the content bucket (6) provided in a scrollable format within the deal panel. Users can scroll and view embedded video, images, and can click links that can drive traffic to destinations outside of the App.

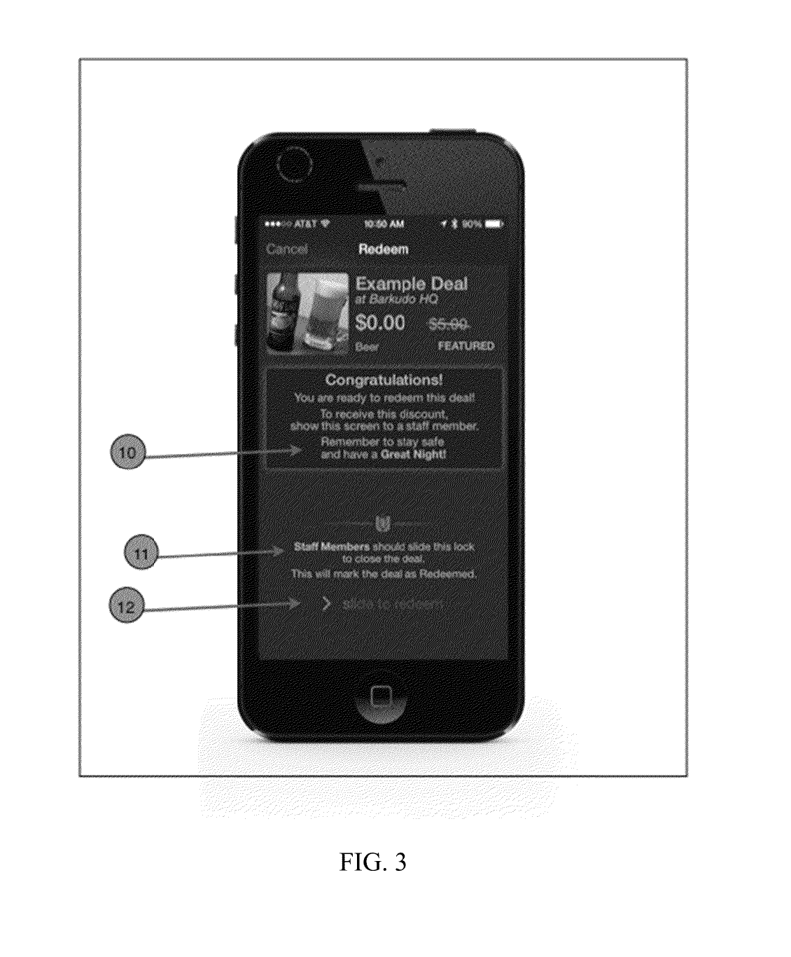

Significantly, the Redeem this Deal button (7) launches an in-app “Redeem Screen” modal (FIG. 3) that the customer may present to the staff of the participating venue.

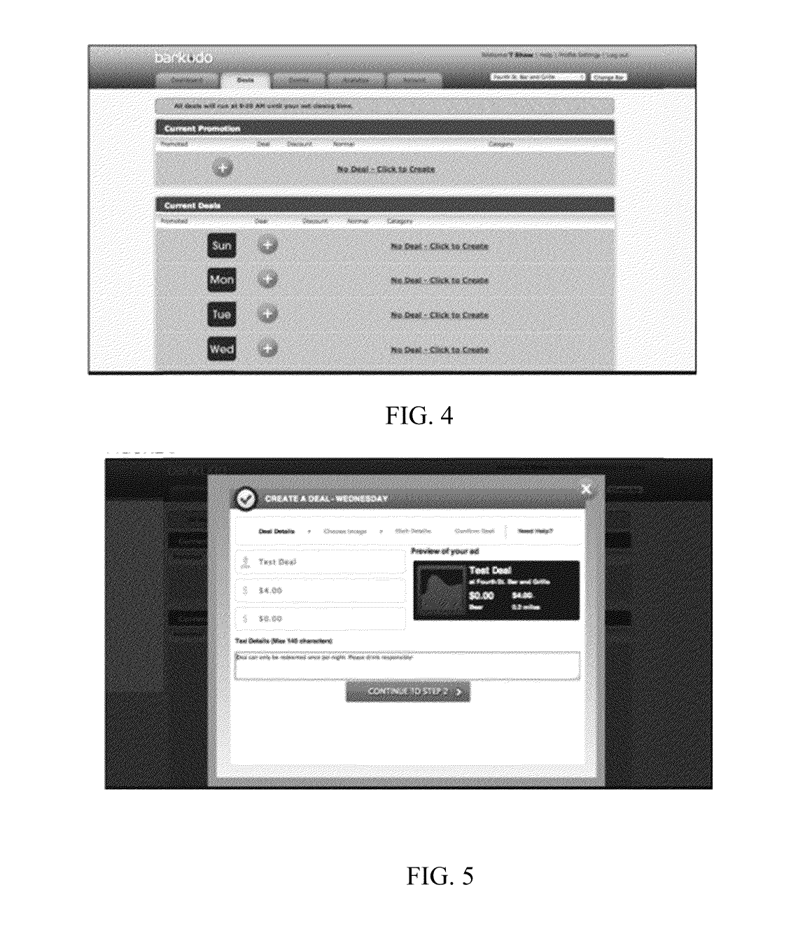

The “Redeem Screen” (FIG. 3) contains information to both the consumer (10) and the bar staff (11) regarding the process by which the deal can be redeemed. The bar staff or the customer may “redeem” the deal by following the instructions (12). The App may prevent a user from redeeming a deal more than once. The App is also able to create a maximum number of redeems on a particular deal. Both of these parameters can be adjusted within the client-side web portal (FIG. 4).

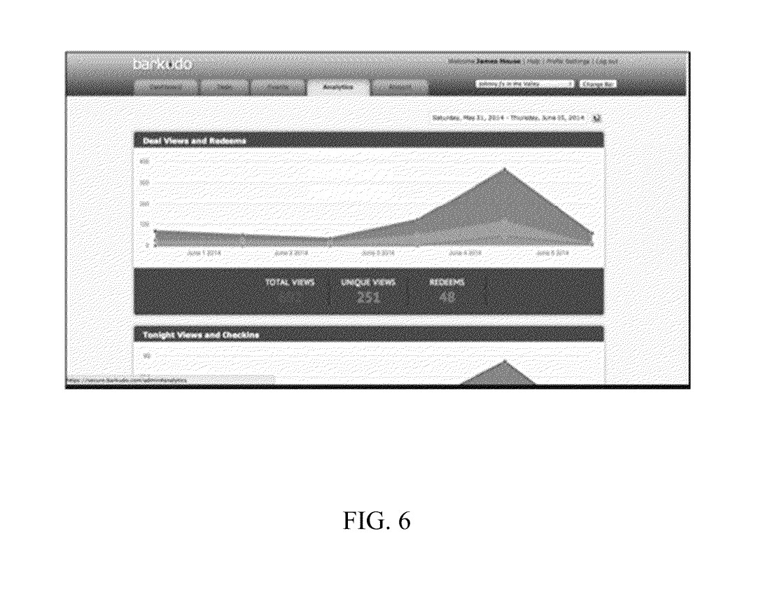

The client-side web portal of the App allows individual account to log in and access unique and private statistics regarding their account's activity (FIGS. 4,5,6). Client accounts are able to see current deals (FIG. 4), create new deals (FIG. 5), and review analytics regarding current and past deal activity (FIG. 6).

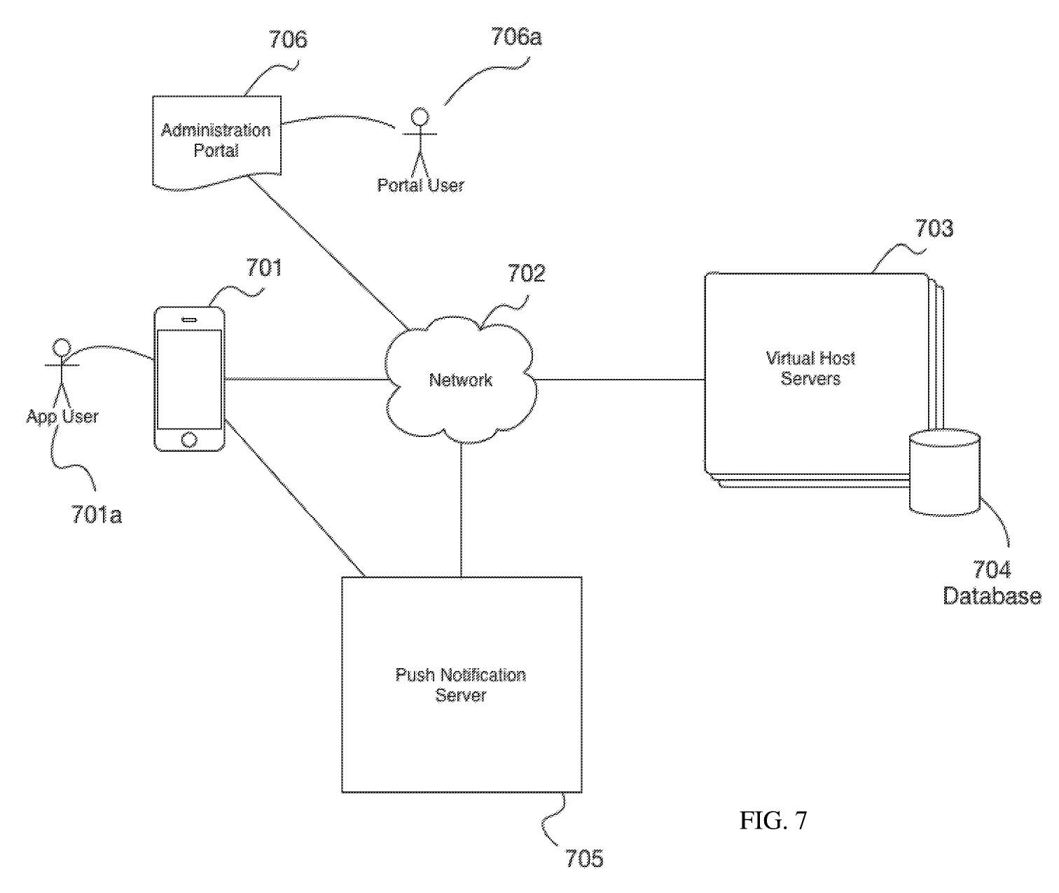

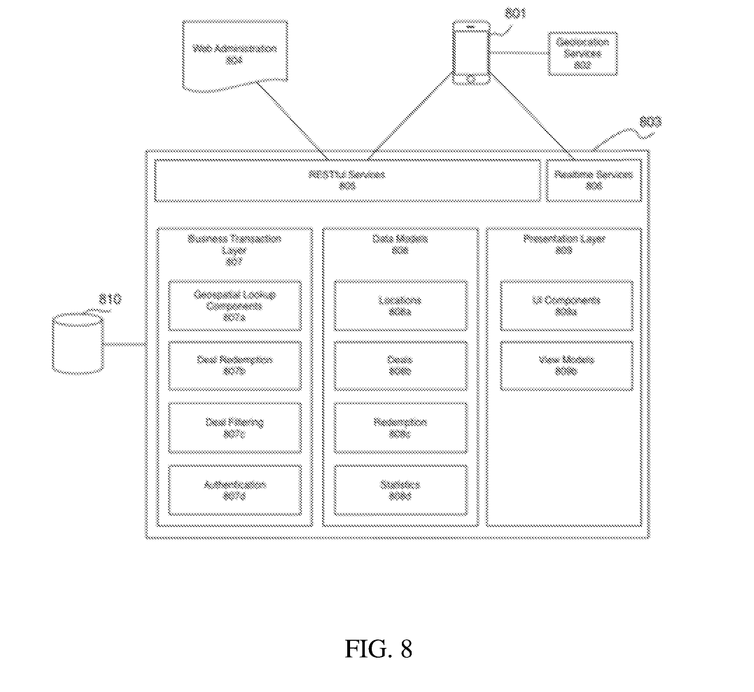

FIG. 7 depicts a diagram of the high level interaction of the client devices (701) as related to the example App. The client devices (701) communicate through the network (702) to the backend cloud hosted servers (703). The server components (FIG. 8) use a distributed database system (704) for persistence of the deal sample data, location data as well as statistics associated with the deal.

The client devices (701) can be but not limited to mobile devices, client computers, server desktops or handheld devices. These devices, however, should have the facility of doing a geolocation lookup to get latitude and longitude and also must have a way of uniquely identifying the device consistently. These elements are used to do lookups for the deal samples and to prevent duplicate redemptions. The user (701a) in this scenario are the consumers of a promotional sample or deal using the Barkudo app on a portable computing device such as a smartphone, cell phone, tablet, smart watch, etc.

For the inventions current case we develop the client side apps (701) in iOS and Android. These are built in Objective-C and Android Java using X-Code and IntelliJ Idea and shipped to the Apple Appstore and Google Play stores respectively. This allows a widespread distribution of the apps and make them available to consumers by just downloading them to their devices. Since all smartphone devices also have geolocation capability this was an easy target to deploy to.

On the server side (703) the invention currently use a ruby on rails, and cloud hosting through amazon web services and heroku (703) to offer the RESTful servicing as well as to create the vendor portal. On the database side we use a distributed database (704) built on PostgreSQL to store all the data and redis is used to cache realtime communication channels to the client.

The technology, however, is subject to change and doesn't necessarily relate to the invention as it is presently practiced. The backend technology is separated from the client layer so we can swap out technologies in either place such as creating a smart watch app or totally re-building the backend in a new technology such as Scala or Node.

The push notification servers (705) are used for communicating with client devices (701), such as a portable user device (cell phone, smart phone, tablet, etc.) that support but not limited to Apple Push Notification Services (APNS) push or Google Cloud Messaging (GCM). This is used mainly for short communications to end user. Such a push server might be provided at the vendor location in order to communicate with the portable user device.

The administration portal (706) is where the merchants and administrators (706a) register and create deal samples as well as location data and view statistics on deal performance. This uses the server components (FIG. 8) and the distributed database (704) to store data for later presentation and redemption on the client devices (701).

FIG. 8 depicts the high level components involved in the interaction of the deal redemption. The client (portable user) devices (801) gather data related to deal samples around their area by passing geolocation (802) information to the Barkudo server (803) using RESTful services (805) and Realtime Services (806).

The RESTful services (205) are the primary interaction with the business transactions layer (807) and the data models (808) and are for ad-hoc requests for deal lookups, location information, facilitating redemptions, user registration and is also used by the web administration portal (804) to create and view deal information.

The realtime services (806) are for realtime updates to the deals and location data to the client devices (801) in realtime and can also be used for other channels to trigger events based on deal or location updates.

The business transaction layer (807) sits behind the RESTful services (805) and the realtime services (806) for, but not limited to: 1) Performing lookups using geospatial recognition (807a) to filter deals (807c) associated to the user request; 2) Handling user authentication (807d); 3) Filtering or restricting deals already redeemed by the current user based on a unique token sent to the RESTful services layer (805) and other parameters such as deal schedule and promotions; 4) The redemption of deal samples (807b) and handle business rules such as restricting the radius in which a user can redeem; 5) Gathering statistics (808d) based on deal performance and redeem rates; and 6) Interact with the Data Models (808) and persisting associated data in the distributed database (810).

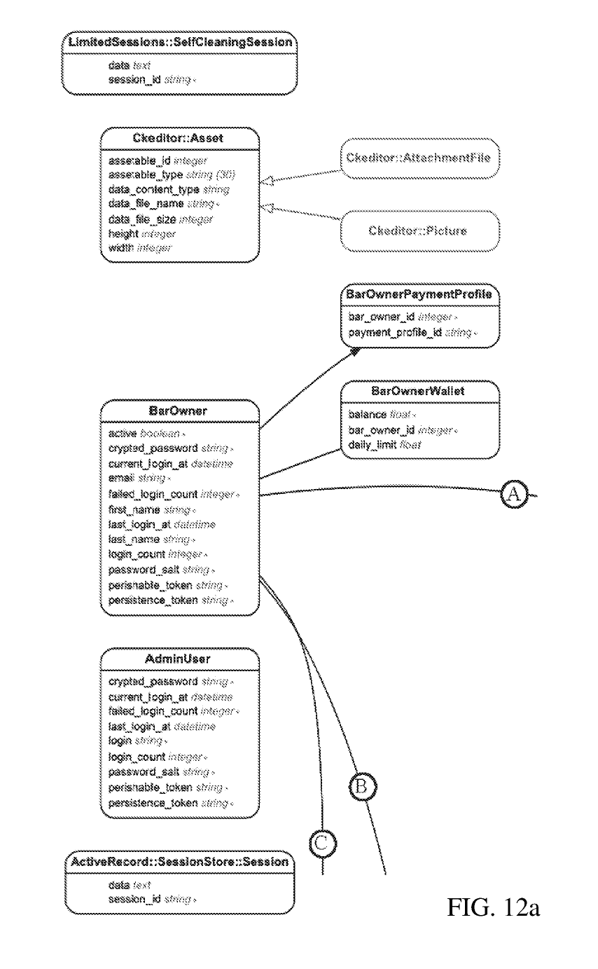

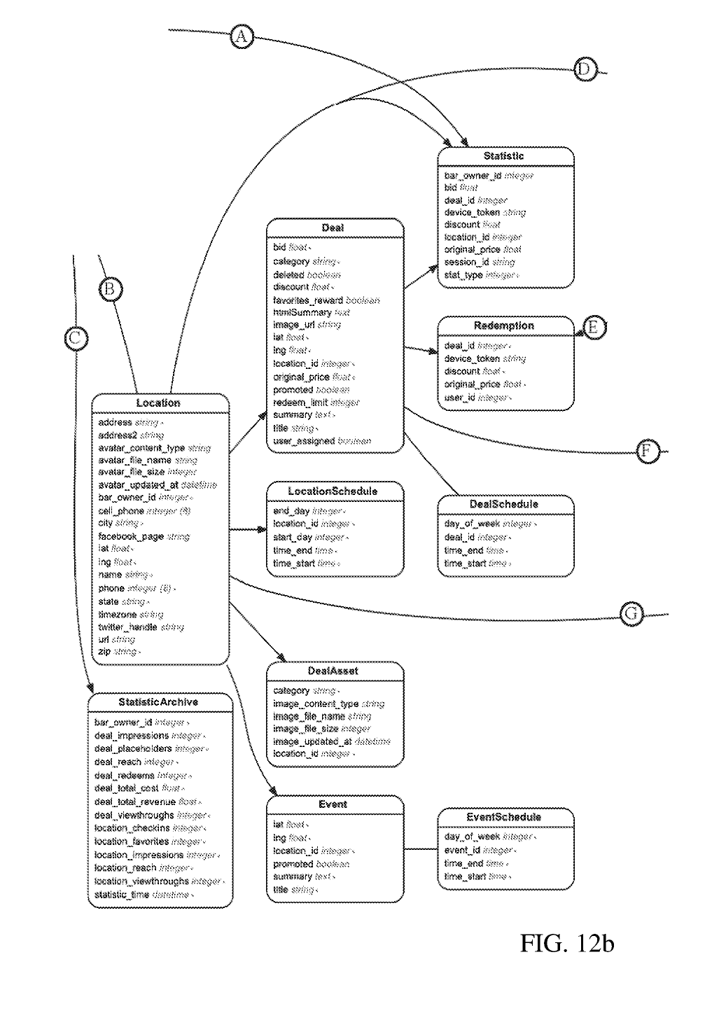

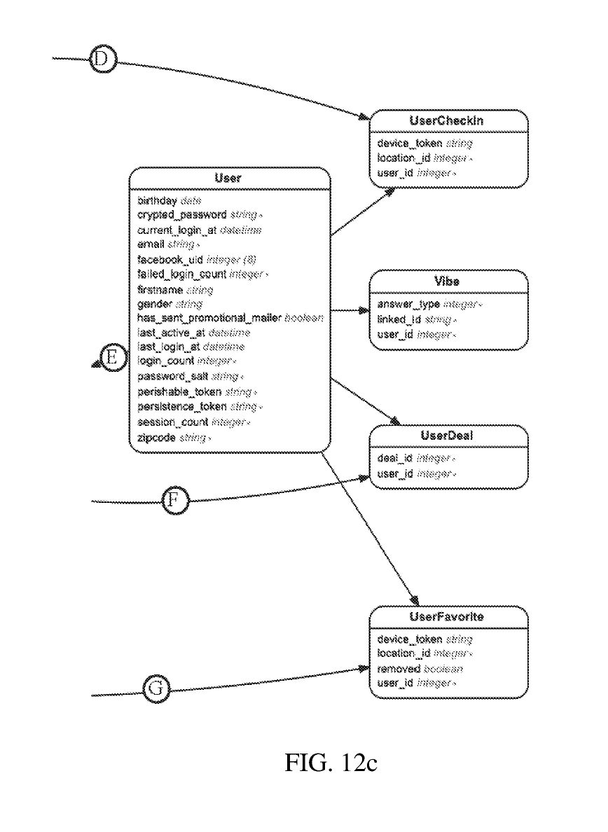

The data models (808) facilitate the interaction between the business transaction layer (807) and persist the associated data in the distributed database (810). This performs validation, data integrity, locking and lookups for all data associated with the App (see FIG. 12).

The presentation layer (809) is used by the web administration portal (804) and provides common user interface components (809a) and binding to data models (808) through view specific models (809b). The web administration portal (804) is used by merchants to create deals, look at statistical performance and update location related information.

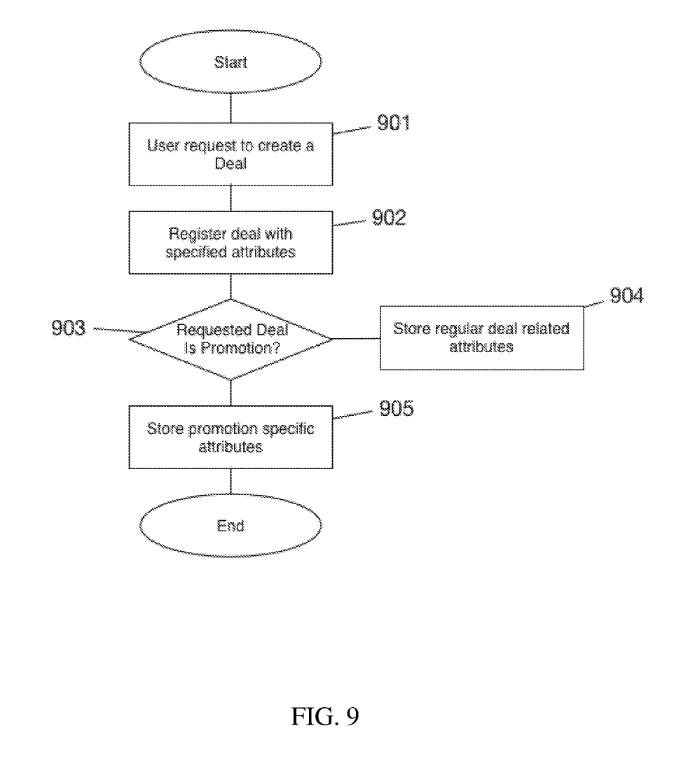

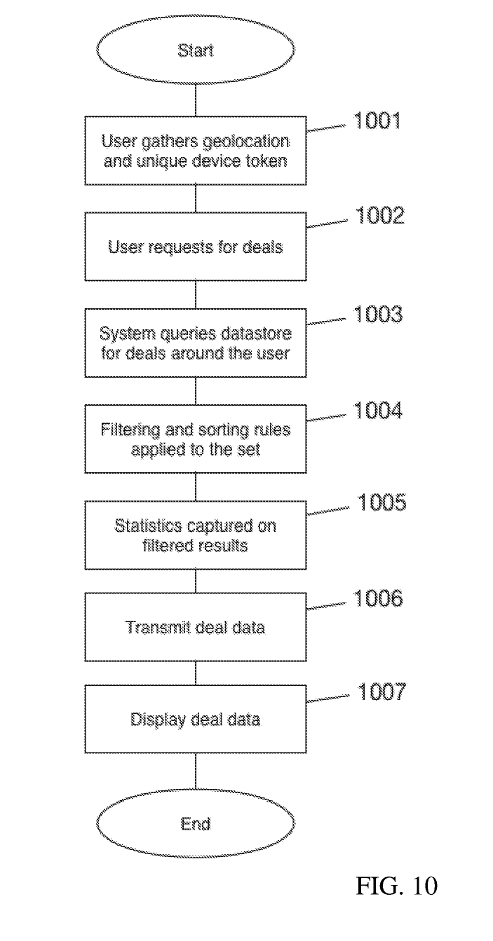

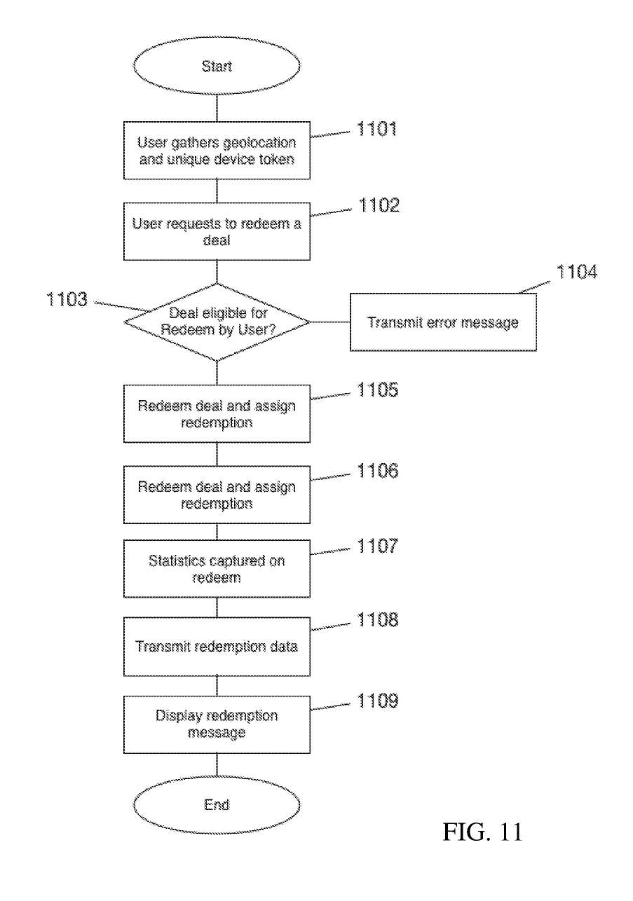

FIG. 9 depicts a simple flowchart showing how a deal sample is registered with the system. Firstly, an authorized user requests to create a deal (901). This will register an uncommitted deal (902) with default attributes (FIG. 12) based on the type and present it to the user. If the deal is a promotion (903) these attributes and display are handled differently than regularly scheduled deals. A promotion also has several unique attributes that govern how many times a deal can be redeemed (FIG. 11). For example a promoted sample has no schedule and is run until the redemption count is equal to the number of samples registered for the deal. These attributes can also govern filtering rules (FIG. 10) and redemption logic (FIG. 11) as it pertains to the sample and location a deal is offered for. Once the deal is requested to be saved (904, 905) it is validated and committed to the distributed database system (FIG. 8, 810) and immediately available to the app (FIG. 8, 801) through the service layer (FIG. 8, 805) providing its display rules allow it to be shown. The client (user) can accept the offer to receive or purchase the offered product.

FIG. 10 illustrates a flowchart showing the process of a deal lookup. The client device (FIG. 8, 801) is used to gather geolocation data and a unique unchangeable device token (1001) and makes a request for deal lookup (1002) to the server layer (FIG. 8, 803). This data is then used to do a geospatial lookup (1003) against the distributed data store (FIG. 8, 807a, 810) and filtered and sorted (1004) based on the current users redemptions and other rules. These filtering rules include, but not limited to: 1) Verifying the deal has a valid schedule to be shown; 2) Deal eligibility rules for the current user; 3) Filtering regular deals when sample promotions are being run; 4) Time threshold data in accordance to the defined time period allowed and time zone the request is made for; and 5) Sorting by popular or distance based results and deal weighting based on the statistics and attributes captured on that current deal. The system then captures statistics on the resulting set (1005) based on the request made and stores them in the distributed data store for display and deal weighting later.

“Deal weighting” is the process of determining deal ranking based on, but not limited to 4 key metrics: 1) Impression: User has seen the deal; 2) View Through: User has requested more information about the deal; 3)•Placeholder: User has saved the deal and/or attempted to redeem the deal; and 4)•Redeem: User has redeemed the deal.

Each metric is used to give a weight to the deal or sample and determine the order in which the result is displayed and depending on the request this rank can filter out deals with lower popularity. On top of this, each of the key metrics themselves are given different priority to place importance on how the resulting set is weighted. Finally, the resulting data set is transmitted the client device (1006) and displayed appropriately for the current request.

FIG. 11 illustrates the process of redeeming a sampling promotion or deal. The client device (FIG. 8, 801) is used to gather geolocation data and a unique unchangeable device token (1101) and makes a request to redeem the deal (1102) (i.e., accept the offer) to the server layer (FIG. 8, 803). This information is used to check several rules on eligibility pertaining to the user and device information (1103). This includes, but not limited to: 1) The devices location and the proximity of the bar; 2) Rules on deal eligibility depending on the deal type (sample or scheduled deal); and 3) Rules on user and device eligibility based on the unique device token.

If the any of these rules fail, the user receives an error message pertaining to the failure (1104). If the redemption is successful, however, a redemption is assigned (1105), validated and committed in the distributed data store (FIG. 8, 807a, 810) and statistics are processed and recorded (1107). The response is then transmitted to the user (1108) and displayed accordingly (1109).

When this process is finished and committed, the client devices (FIG. 8, 801) trigger refreshed deal lookup (FIG. 10) using a combination of real-time channels (FIG. 8, 806) for connected clients and the RESTful servicing layer (FIG. 8, 805) for on-demand requests. This ensures the data is always kept in-sync with the client device (FIG. 8, 801) and eligibility rules.

Various computer hardware networked together can be utilized for implementing example systems to practice one or more of the example embodiments described herein. The disclosed servers may comprise one or more computers with memory connected to one or more databases for storing the various software applications and data used by the system. The various computer/communications networks utilized for networking the servers and devices may comprise one or more cellular networks the Internet, and one or more internal networks (e.g., an intranet). Any of these networks may utilize cellular networks, WiFi networks, Bluetooth networks, and other near-field communication solutions, among others. The portable personal computing devices may include, among others, tablets, smartphones, cell phones, laptops, smart watches and personal computers, among others

Various vendor/retailers can have various computing equipment, such as servers, computer terminals, cash registers, and/or credit card readers connected to a local communication network that communicates with the portable communication devices of consumers, for implementing any of the disclosed embodiments, as desired.

As will be appreciated by one of skill in the art, examples of the disclosed embodiments discussed above may be embodied as a method, a system, a computer program product, software executing on a processor/computer, or a combination of the foregoing. The example embodiments discussed herein may take the form of an entirely hardware implementation, or an implementation that combines software (including firmware, resident software, microcode, etc.) and hardware components. The software may be stored on a computer usable storage medium having computer-usable program code embodied in the medium, which may be packaged as a computer program product. Any suitable computerized device comprising a processing component (e.g., a processor) and a computer readable medium may be utilized for providing example embodiments.

Generally, a computer usable or computer readable medium may be any medium that can contain, store, communicate, propagate, or transport the program for use by or in connection with the instruction execution system, platform, apparatus, or device. The computer usable medium may include a propagated data signal with the computer-usable program code embodied therewith, either in baseband or as part of a carrier wave. The computer usable program code may be transmitted for execution using any appropriate medium, including but not limited to, computer memory busses, the Internet, wireline, POTS, optical fiber cable, radio frequency (RF) or other means. The computer readable medium may comprise, for example but not limited to, an electronic, magnetic, optical, electromagnetic, infrared, or semiconductor system, apparatus, device, database, or propagation medium. More specific examples of the computer readable medium would include, but are not limited to, a computer diskette, a hard disk, a random access memory (RAM), a read-only memory (ROM), an erasable programmable read-only memory (EPROM or Flash memory) which may be internal or external, permanent or removable, a compact disc read-only memory (CDROM) or random access memory (CDRAM), or any other tangible optical, electrical, magnetic, or other storage device; or storage found on transmission media such as those supporting the Internet or an intranet, including temporary cache memory.

Computer program code for carrying out operations of the example embodiments may be written by conventional means using any computer language, including but not limited to, an interpreted or event driven language such as BASIC, Lisp, VBA, or VBScript, or a GUI embodiment such as visual basic, a compiled programming language such as FORTRAN, COBOL, or Pascal, an object oriented, scripted or unscripted programming language such as Java, JavaScript, Perl, Smalltalk, C++, Object Pascal, or the like, artificial intelligence languages such as Prolog, a real-time embedded language such as Ada, or even more direct or simplified programming using ladder logic, an Assembler language, or directly programming using an appropriate machine language.

Example computer program software for implementing the features described above comprises computer program instructions that are executed by providing the instructions to an executing device or component, which can include a processor of a general purpose computer, a special purpose computer or controller, or other programmable data processing apparatus or component, such that the instructions of the computer program, when executed, create means for implementing the functions/acts specified in the flowcharts and/or block diagram block or blocks shown some of the figures. Hence, the computer program instructions are used to cause a series of operations to be performed on the executing device or component, or other programmable apparatus to produce a computer implemented process such that the instructions which execute on the computer or other programmable apparatus then perform at least some the steps for implementing the functions/acts specified in this disclosure. These steps or acts may be combined with operator or human implemented steps or acts and steps or acts provided by other components or apparatuses in order to carry out any number of example embodiments of the invention.

The flowcharts and/or block diagrams illustrate example architecture, functionality, and operation of possible implementations of systems, methods and computer program products according to various example embodiments. In this regard, each block in the flowchart or block diagrams may represent a module, segment, or other portion of code that makes up the software, and thus which comprises one or more executable instructions for implementing the specified logical function(s). It should also be noted that, in some alternative implementations, the functions noted in the block may occur out of the order noted in the figures. For example, although the functions of two blocks shown in succession are typically accomplished in series, they may, in some circumstances where not logically inconsistent with the disclosure, be executed substantially concurrently, or the functions may sometimes be executed in the reverse order, depending upon the functionality involved. It will also be noted that each block of the block diagrams and/or flowchart illustration, and combinations of blocks in the block diagrams and/or flowchart illustration, can be implemented by a number of alternative solutions, including the use of special purpose hardware-based systems which perform the specified functions or acts, or combinations of special purpose hardware and computer instructions.

Naturally, to satisfy specific needs, a person skilled in the pertinent arts may apply modifications to the preceding description. The present disclosure is not limited to the embodiments described, and other variants and combinations of characteristics are possible.

The example embodiments have been described and illustrated in the present detailed description in reference to the attached figures. However, possible related embodiments are not limited to the embodiments presented herein. Other variants and embodiments can be deduced and executed by the person competent in the pertinent field on reading the present description and attached figures.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A method of providing a promotion for an alcoholic beverage, said method comprising the steps of:
providing a software application for installation on a portable user device over a communication network from a remote app server;
installing the software application on the portable user device;
executing the software application on the user device to detect a user location near or at a vendor;
executing the software application on the user device to provide a user interface on the portable user device to collect information about the user;
executing the software application on the user device to receive information about an offer to sample or purchase a product at the vendor from a computer system located remotely from the vendor;
executing the software application on the user device to provide a user interface on the portable user device to display the offer at the vendor;
executing the software application on the user device to provide a user interface on the remote device to receive a user input regarding acceptance of the offer;
if the offer is accepted via the user interface, executing the steps of:
the software application on the user device providing information about the offer to the computer system,
the computer system providing information about the accepted offer to a vendor device located at the vendor location,
after delivery of the product, the vendor device sending product promotion information over the communication network regarding the delivered product to the computer system,
the computer system executing software for preparing a promotion report based on the product promotion information and the information about the user, and;
transmitting the promotion report to a supplier computer system over the communication network.

2. The method of claim 1, wherein if the offer is accepted via the user interface, a number of other offers provided to the portable device on the same day is limited to a predetermined number.

3. The method of claim 1, wherein a payment must be provided to the vendor by a patron using the portable device prior to delivering the product.

4. The method of claim 3, wherein if the offer is accepted via the user interface, a payment is subsequently provided by the supplier to the vendor.

5. The method of claim 1, wherein if the offer is accepted via the user interface, a payment is subsequently provided by the supplier to the vendor.

6. The method of claim 1, wherein said user device also sends information about the accepted offer to the vendor device.

7. A system for executing the method of claim 1, said system comprising a portable computing device for use by a consumer, a vendor device, one or more servers comprised in the remote computer system, and a supplier computer system.
